(19) United States
(12) Patent Application Publication
(10) Pub. No.: US 2004/0064455 A1
(43) Pub. Date: Apr. 1, 2004

(54) Software-floating palette for annotation of images that are viewable in a variety of organizational structures

(75) Inventors: Elizabeth Rosenzweig, Newton, MA (US); Andrew Sailus, Brockport, NY (US); Barry P. Lukoff, Rochester, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/255,512

(22) Filed: Sep. 26, 2002

(51) Int. Cl. G06F 17/00

(52) U.S. Cl. 707/100

(57) ABSTRACT

In order to annotate digital images that are presented for viewing in a plurality of organizational structures provided by different application programs run on a common operating system, a selected application program is opened, thereby selecting a particular organizational structure and displaying the digital images associated therewith according to a view provided by the organizational structure. Such organizational structures include hierarchical, time-line and album structures. An annotation routine is provided that operates as a layer of the operating system for listing potential labels that may be associated with a digital image. Because of its relationship to the operating system, the annotation routine is available concurrently with currently displayed images regardless of the application program that is currently open. Then a label is easily appended to a digital image appearing among the currently displayed images without having to open any application for that purpose.

### FIELD OF THE INVENTION

The invention relates generally to the field of image processing, and in particular to the annotation and retrieval of selected images from a database.

### BACKGROUND OF THE INVENTION

With the advent of digital photography, consumers now are capable of easily accumulating a large number of images over their lifetime. These images are often stored in “shoeboxes” (or their electronic equivalent), rarely looked at, occasionally put into albums, but usually laying around, unused and unlooked at for years.

The “shoebox problem” is particularly relevant, because “shoeboxes” are an untapped source for communicating shared memories that are currently lost. After initially viewing pictures (after they are returned from film developing or downloaded to a computer), many people accumulate their images in large informal, archival collections. In the case of hardcopy photos or printouts, these pictures are often accumulated in conveniently-sized shoeboxes or albums. Images in shoeboxes, or their electronic equivalent in folders or removable media, are often never (or very rarely) seen again, because of the difficulty of retrieving specific images, browsing unmanageably large collections and organizing them. Typically, any organizing apart from rough reverse-chronological order involves so much effort on the part of the user that it is usually never performed. Consequently, retrieval is an ad hoc effort usually based on laborious review of many, mostly non-relevant, images.

Potentially, of course, the images could be annotated with text labels and stored in a relational database and retrieved by keyword. However, until computer vision reaches the point where images can be automatically analyzed, most automatic image retrieval will depend on textual keywords manually attached to specific images. But annotating images with keywords is a tedious task, and, with current interfaces, ordinary people cannot reasonably be expected to put in the large amount of upfront effort to annotate all their images in the hopes of facilitating future retrieval. In addition, even if the images can be automatically interpreted, many salient features of images exist only in the user's mind and need to be communicated somehow to the machine in order to index the image. Therefore, retrieval, based on textual annotation of images, will remain important for the foreseeable future.

Furthermore, retrieval applications themselves are awkward enough that they often go unused in cases where the user might indeed find images from the library useful. For instance, the retrieval itself involves dealing with a search engine or other application that itself imposes overhead on the process, even if only the overhead of starting and exiting the application and entering keywords. Because of this overhead, opportunities to use images are often overlooked or ignored.

It has been recognized that more effective information exploration tools could be built by blending cognitive and perceptual constructs. As observed by A. Kuchinsky in the article, “Multimedia Information Exploration”, CHI98 Workshop on Information Exploration, FX Palo Alto Laboratory, Inc.: Palo Alto, Calif. (1998), if narrative and storytelling tools were treated not as standalone but rather embedded within a framework for information annotation and retrieval, such tools could be leveraged as vehicles for eliciting metadata from users. This observation of a potential path forward, however, is still largely divorced from the contextual use of the images in a viewing application such as albuming of personal photographic collections.

In the paper “Shoebox: A Digital Photo Management System”, by T. J. Mills, D. Pye, D. Sinclair and K. R. Wood (ATT Labs, Cambridge, England, October 2000), a system for the management of personal digital photograph collections provides a range of browsing and searching facilities. Although several views are permitted—including a “roll” view, a time line view and a topic view—annotation is performed in a separate, special session, thereby requiring a significant degree of user initiation and effort. Indeed, the authors acknowledge that users may not be willing to annotate images and may never even wish to perform a search.

Consequently, the conventional view generally remains that annotation and viewing are two completely separate operations, at least in the sense that they are to be addressed by applications operating independently from each other. This leaves the burden on the user to enter and leave applications when appropriate, and explicitly transfer data from one application to another, usually via cut and paste. Users are inclined to think about their own tasks, as opposed to applications and data transfer. Each user's task, such as forming pictures into an album, carries with it a context, including data being worked with, tools available, goals, etc., which tends to naturally separate from the context of other applications. However, there have been some efforts to alleviate this problem.

For instance, in International Patent Application WO 01/61448 A1, which is entitled “Methods for the Electronic Annotation, Retrieval and Use of Electronic Images” and was published Aug. 23, 2001, the author (B. A. Shneiderman) describes a software system for electronically annotating electronic images, such as drawings, photographs, video, etc., through the drag and drop of annotations from a pre-defined, but extendible, list. The annotations are placed at a user-selected x,y location on the image, and stored in a searchable database. This technique allows a user to avoid the need for continually re-keying annotations. As disclosed, this annotation technique is part of a particular image management application, and is opened as a specific window in the user interface of that application.

In commonly assigned U.S. patent application Ser. No. 09/685,112, entitled “An Agent for Integrated Annotation and Retrieval of Images” and filed Oct. 10, 2000 in the names of H. Lieberman, E. Rosenzweig, P. Singh and M. D. Wood (which has been published as European Patent Application EP 1 197 879A2 on Apr. 17, 2002), a method for integrated retrieval and annotation of stored images involves running a user application (e.g., e-mail) in which text entered by a user is continuously monitored to isolate the context expressed by the text. The context is matched with metadata associated with the stored images, thereby providing one or more matched images, and the matched images are retrieved and displayed in proximity with the text. The context is then utilized to provide suggested annotations to the user for the matched images, together with the capability of selecting certain of the suggested annotations for subsequent association with the matched images. In a further extension, the method provides the user with the capability of inserting selected ones of the matched images into the text of the application, and further provides for automatically updating the metadata for the matched images. The approach taken by this system is to try to integrate image annotation, retrieval, and use into a single “application”.

Notwithstanding these efforts, there is a need for an annotation routine that could seamlessly and transparently operate across a variety of image organizational structures, i.e., across “applications” such as directories, albums and time-line presentations, without having to engage the user each time to move in and out of the applications. The routine should also make it as easy as possible for the user to complete the annotation operations whenever and where ever appropriate.

### SUMMARY OF THE INVENTION

The present invention is directed to overcoming one or more of the problems set forth above. Briefly summarized, according to one aspect of the present invention, for digital images that are presented for viewing in a plurality of organizational structures provided by different application programs run on a common operating system, a method of annotation comprises the steps of: providing a plurality of application programs offering a plurality of organizational structures for viewing the images, wherein each structure presents the images according to a different view; opening a selected application program, thereby selecting a particular organizational structure and displaying the digital images associated therewith according to the corresponding view; providing an annotation routine that operates as a layer of the operating system for listing potential labels that may be associated with a digital image, where the annotation routine is available concurrently with currently displayed images regardless of the application program that is currently open; and appending a label to a digital image appearing among the currently displayed images.

In another aspect of the invention, the annotation routine provides an icon appearing concurrently with displayed images regardless of the application program that is currently open. The icon is then opened to display a palette of labels that may be appended to the digital image. Furthermore, the palette includes a plurality of tags for containing labels, and new labels are created by selecting a tag and assigning a label to the selected tag. Similarly, old labels are deleted by selecting a tag and deleting a label that was assigned to the selected tag.

An advantage of the invention is the provision of the user with the ability to access, input and view metadata for digital image files through the direct use of a tag feature without having to open a specific application for so doing, thus easily annotating images, while performing other functions such as viewing, albuming or otherwise working with a personal image database.

These and other aspects, objects, features and advantages of the present invention will be more clearly understood and appreciated from a review of the following detailed description of the preferred embodiments and appended claims, and by reference to the accompanying drawings.

### BRIEF DESCRIPTION OF THE DRAWINGS

FIG. 1 is a functional block diagram of a computer system including the TAGPAD annotation routine in accordance with the present invention.

FIG. 2 is a functional block diagram of elements of the annotation routine shown in FIG. 1.

FIG. 3 is an illustration of a screen layout of the main directory screen of an image viewer, showing an application of a TAGPAD icon in a thumbnail view in accordance with the invention. FIG. 3 is also an example of images that are presented for viewing in a folder-based hierarchical organizational structure.

FIG. 4 is an illustration of a screen layout of the opened TAG PAD icon shown in FIG. 3.

FIG. 5 is a flow chart of the workflow of the tag creation process shown in FIG. 2.

FIG. 6 is a flow chart of the workflow of the annotation process shown in FIG. 2.

FIG. 7 is an example of images that are presented for viewing in a time-line organizational view based on time of capture.

FIG. 8 is an example of images that are presented for viewing in a subject-grouped organizational view based on a collection of images in an album.

### DETAILED DESCRIPTION OF THE INVENTION

Because data processing systems employing annotation features and agents are well known, the present description will be directed in particular to attributes forming part of, or cooperating more directly with, the system and method in accordance with the present invention. Attributes not specifically shown or described herein may be selected from those known in the art. In the following description, a preferred embodiment of the present invention would ordinarily be implemented as a software program, although those skilled in the art will readily recognize that the equivalent of such software may also be constructed in hardware. Given the system and method as described according to the invention in the following materials, software not specifically shown, suggested or described herein that is useful for implementation of the invention is conventional and within the ordinary skill in such arts.

If the invention is implemented as a computer program, the program may be stored in conventional computer readable storage medium, which may comprise, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM) CD, or DVD; or any other physical device or medium employed to store a computer program.

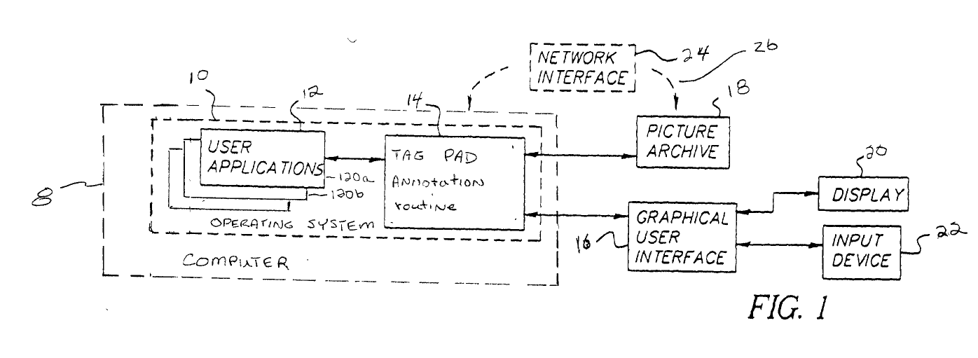

Reference is initially directed to FIG. 1 which is a functional block diagram of systems, software applications and routines that run on a computer 8 in an illustrative embodiment of the present invention. The computer 8 may be a conventional personal computer or similar computer workstation including a processor, memory, power supply, input/output circuits, mass storage devices and other circuits and devices typically found in a computer. An operating system 10 controls the computer 8 and makes it possible for users to enter and run their own programs on the computer 8. For instance, one or more user application programs 12, which for exemplary purposes are several different types of picture generators, runs on the computer 8. Under control of the operating system 10, the computer 8 recognizes and obeys commands typed, or otherwise entered, by the user. In addition, and in accordance with the invention, an image annotation routine 14, herein referred to as the TAG PAD routine, runs as part of, or as a layer of, the operating system 10, which allows the application programs 12 to perform input-output operations relative to the annotation routine 14 without having to specify or open any particular software configuration or application for that purpose. Since such routines are typically utilized in an operating system, albeit for other purposes, their design is within the capabilities of one of ordinary skill in operating system programming.

More specifically, regardless of the applications that are presently open on the operating system 10, the TAG PAD routine 14 can be directly called by the user without having to leave any current application or open any other application. In this sense, the annotation routine 14 is said to “float” across all the application programs 12, that is, in the sense of a “software-floating” palette of user-enabled choices. The computer 8 includes a processing unit (not shown) that is coupled to a graphical user interface 16 and to a picture archive 18. The graphical user interface 16 provides a functional interface with a display 20, which serves as a visual interface to the user and may be any of the commonly used computer visual display devices, including, but not limited to, cathode ray tubes, matrix displays, LCD displays, TFT displays, and so forth, and with an input device 22, which is typically a click initiating device such a mouse, but could be other input devices such as a keyboard, touch screen, character recognition system, track ball, touch pad, or other human interface device or peripheral.

The TAG PAD routine 14 communicates through the operating system 10 with a graphical material database. In the preferred embodiment, the database is the digital image archive 18, which stores an archive of still images; alternatively, or in addition, the database could include a digital video database storing motion video sequences. Such a database comprises a number of digital graphical and/or image materials that are accessible by a search function. Typically, the database is a relational database indexed by a plurality of indices. The conventional approach to search such a database is to provide one or more prioritized keywords. The database responds to such a request with a search result that lists a number of hits.

It is understood by those skilled in the art that databases such as the archive may use more sophisticated indexing strategies and that any such database would be applicable to the present invention. For example, the images may be indexed based on image content descriptors, rather than keywords. Where keywords may describe the circumstances surrounding the image, that is, the who, what, where, when, and why parameters, content descriptors actually describe the data within the digital graphical material. Such factors are derived from the image itself and may include a color histogram, texture data, resolution, brightness, contrast and so forth. Besides typical image originating devices, such as a film scanner or a digital camera, the image material may be sourced from existing databases such as stock photo databases or private databases. It is also foreseeable that public sites will develop for dissemination of such graphical and/or image materials.

The picture archive 18 may reside within the computer 8, e.g., in the mass memory of a personal computer, or it may be external to the computer. In the latter case, the processing unit of the computer 8 may be coupled to the picture archive 18 over a network interface 24. The network interface is here illustrated as being outside of the computer 8, but could be located inside the computer as well. The network interface 24 can be any device, even a simple conductive circuit, to interface the processing unit to an external network 26 such as the Internet. However, the network utilized could be a private network, an intranet, a commercial network, or other network, which hosts a database of graphical data. Respecting the network interface device 24, this could be a conventional dial-up modem, an ADSL modem, an ISDN interface, a cable modem, direct hardwire, a radio modem, an optical modem or any other device suitable for interconnecting the computer 8 to an external network 26, as herein described.

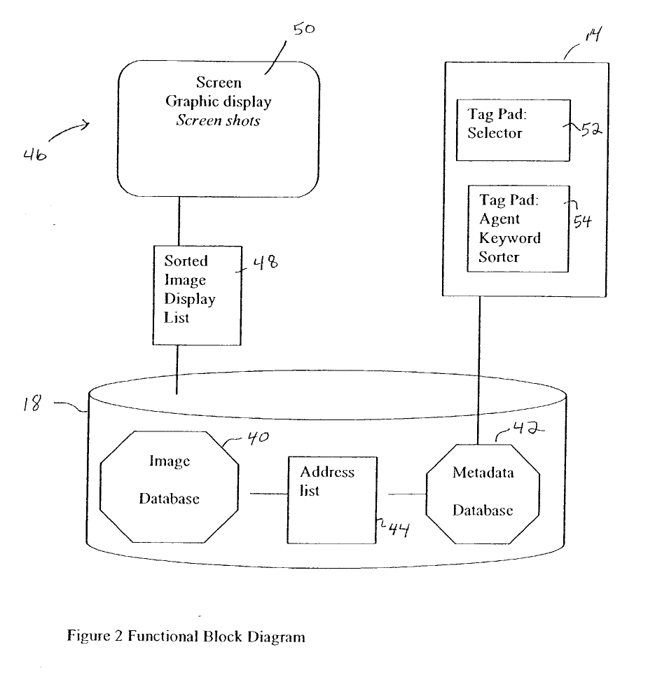

Referring to FIG. 2, the TAG PAD routine 14 involves several logical components, as follows. The picture archive 18, as was described earlier, provides storage of picture objects, including representations of images, in an image database 40 and storage of their associated metadata in a metadata database 42, which includes keywords or other key information (e.g., content and category information) associated with the images. An address list 44 links the metadata to the images in the image database. A picture database viewer 46 provides a navigational facility for viewing the contents of the picture archive 18 on the display 10 based on a sorted image display list 48. The contents are viewed in the form of a screen graphic display (i.e., screen shots) 50. The picture database viewer 46 also includes conventional functionality for allowing pictures or phrases to dragged and dropped, or otherwise moved, from one window into another window of the user application.

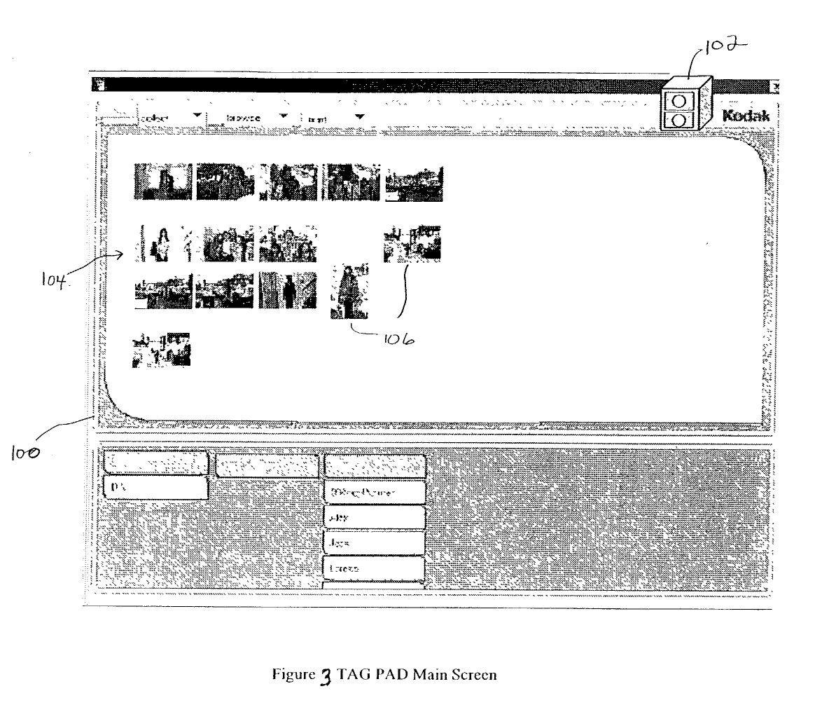

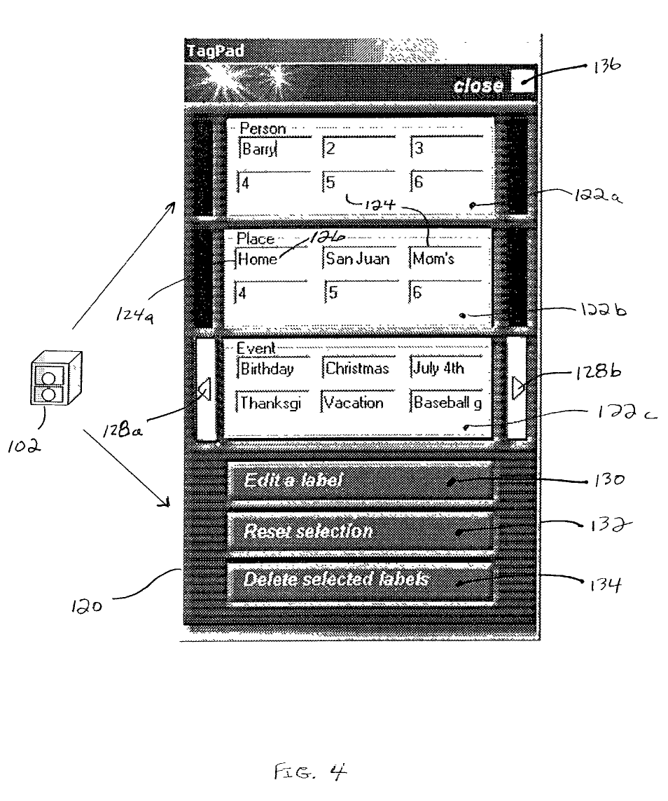

In accordance with the invention, the TAG PAD routine 14 provides the user with the ability to input metadata for digital image files, thus easily annotating images, while performing other functions, such as viewing, albuming or otherwise working with a personal image database in one or more different applications. As shown in FIG. 2, the TAG PAD routine 14 provides functionality for a TAG PAD selector 52 and a TAG PAD agent keyword sorter 54 for sorting keywords. As shown in the screenshot of the main directory screen 100 in FIG. 3, a TAG PAD icon 102 is displayed anywhere that a thumbnail view 104 is available of individual thumbnail images 106, but in the preferred embodiment only when the thumbnail view 104 is displayed. Using the input device 22, the user can click on the icon 102, and it will open to the TAG PAD palette 120 shown in FIG. 4. In the preferred embodiment, the TAG PAD palette 120 displays three category sets 122a, 122b and 122c of six tags 124 in each set. Each tag includes an alphanumeric label 126, such as the label “Home” included within the first place tag 124a. In a typical application, each category set will refer to a particular category of metadata, such as the names of persons, places and events. If a user has more than six tags in a category, then the TAG PAD palette 120 will be displayed with scrolling arrows 128a and 128b to allow (by clicking on the arrows) the user to scroll back and forth within the category. In addition, the TAG PAD palette 120 includes an edit button 130, a reset button 132, a delete button 134 and a close button 136.

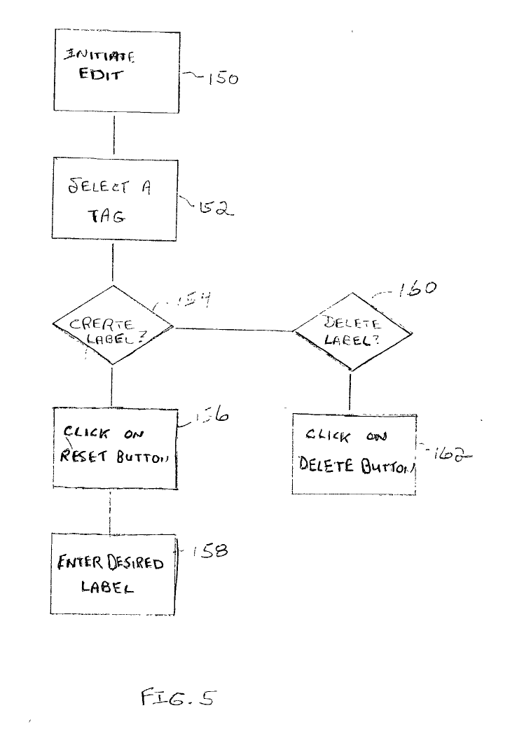

The TAG PAD is a single window pallette that provides two functionalities that are always available to the user when the TAG PAD palette 120 is open: the CREATE TAG function and the TAG function. Before tags, and their corresponding labels, can be assigned to images, they need to generated. As shown in the workflow diagram in FIG. 5, the CREATE TAG function is initiated through a simple and straightforward interface. The process of generating a TAG PAD label begins with an initiate edit step 150, where the edit button 130 is clicked. Before any tag label is created, the tag labels are set to numbers, as shown in FIG. 4. Then a particular tag is selected in a tag selection step 152 by clicking on a desired tag location. If the user positively answers the create label query 154, then the tag label is reset by clicking on the reset button 132 in a reset step 156. Afterwards, the user enters the desired label for the tag in a labeling step 158. If the user responded negatively to the create label query 154, and positively to the delete label query 160, the user can click on the delete button 134 and the label will be deleted from that particular tag location in a delete step 162. When the close button 136 is clicked, the TAG PAD palette 120 is reduced to the TAG PAD icon 102.

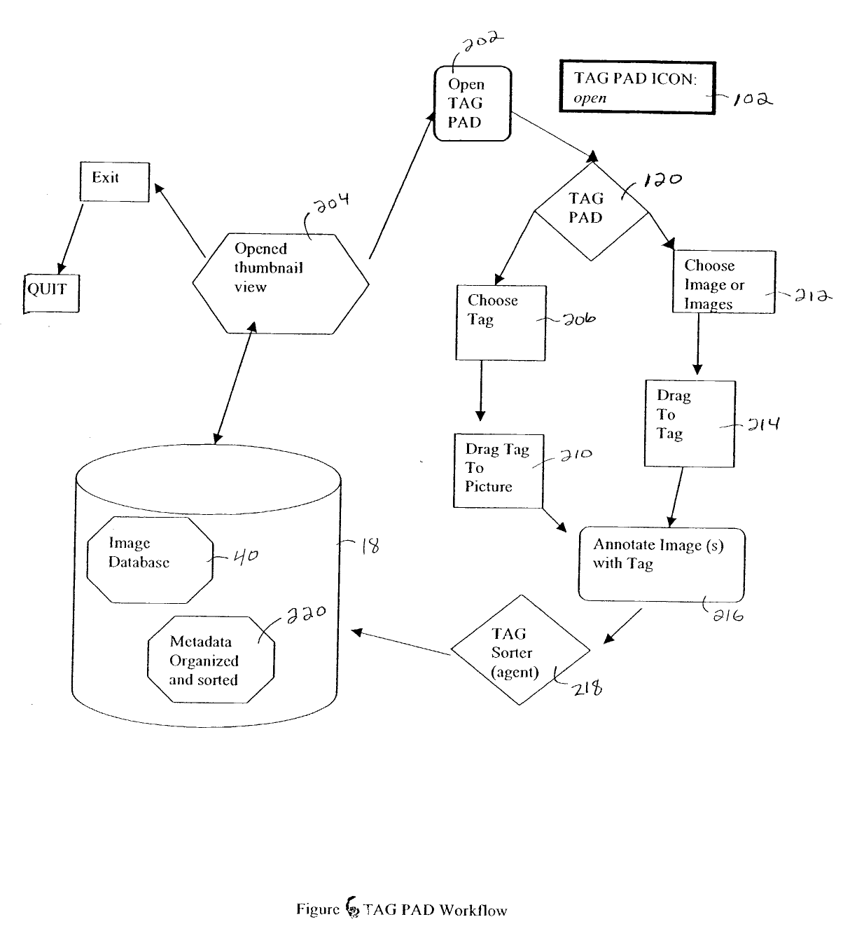

FIG. 6 demonstrates the basic work flow of the TAG function, that is, a TAG annotation operation performed by the system on images opened as thumbnail views from the image database. The user can click on the TAG PAD icon 102 to open the TAG PAD (open step 202) in order to annotate an opened thumbnail view 204 of an image. The user then has two options: to annotate the image either by dragging the annotation to (and dropping into) the image, or by dragging the image to (and dropping into) the annotation. The first option is performed by choosing a tag (tag choice step 206) from the TAG PAD palette 120—that is, from the three category sets 122a, 122b and 122c of six (or more) tags 124 in the TAG PAD palette 120—and dragging the tag (drag tag step 210) to the opened thumbnail picture. Otherwise, an image may be chosen (image choice step 212) and dragged to the location of the tag (drag image step 214) in the TAG PAD palette 120. In either case, the image is annotated with the tag (annotation step 216), and the annotation results are processed by the TAG sorter (sort step 218). The new pieces of metadata, i.e., the new TAG assignments, are then organized and sorted (metadata organize and sort step 220) in the metadata component 42 of the picture archive 18. As explained earlier, the relationship of the metadata to images in the database 40 is maintained by the address list 44 (see FIG. 2).

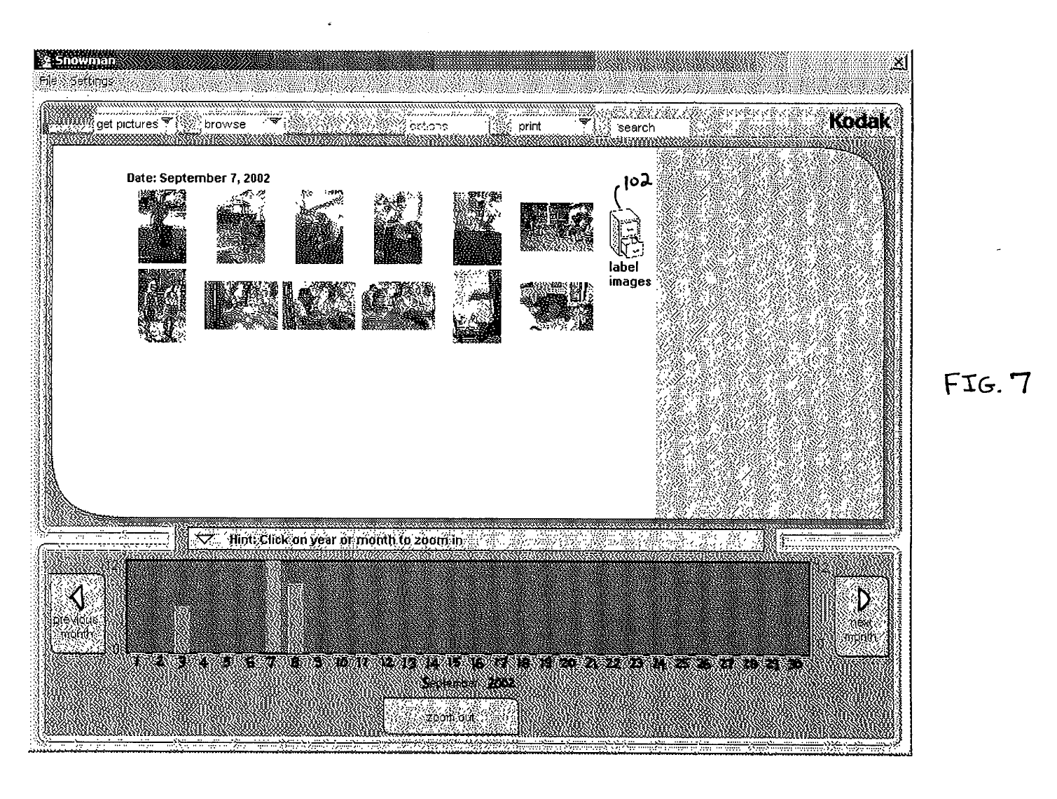

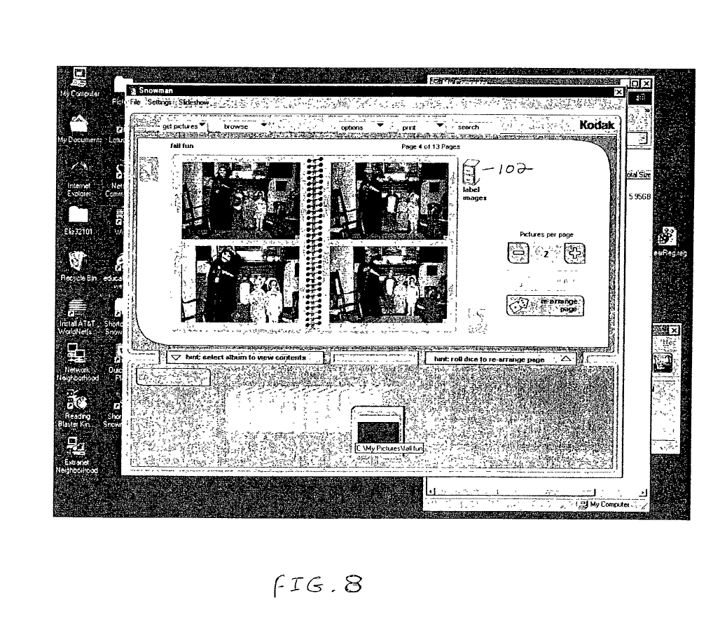

In the preferred embodiment, the TAG PAD annotation routine runs as a layer of the operating system 10, and therefore can be initiated regardless of whatever application 120 may be running on the system. This means that the TAG PAD icon 102 (see FIG. 3) is an icon that floats across all applications running on the computer 8, and may be opened to the TAG PAD palette 120 at anytime (see FIG. 4). Thus the disclosed method for annotating digital images can handle images that are presented for viewing in a plurality of applications providing different views from different organizational structures. Typical views include, without limitation, hierarchical, time line and album views in which the stored images are linked with a folder-based hierarchical structure, a the time of capture structure, and with a subject groupings structure, respectively. For example, as shown in FIG. 3, the thumbnail view 104 is derived from a folder-based hierarchical structure produced by an application program 120a (referring to FIG. 1), where all the images in a given folder are displayed (each folder might correspond without limitation to a particular download from a digital camera, or to images scanned from a particular roll of film, or entered off the Internet as a related group). As shown in FIG. 7, the thumbnail view is derived from a particular time line structure produced by a different application program 120b, where the images are presented in the order of capture date and/or time (which may be obtained without limitation from data provided by the camera that captures the images or from user entries or from when the images—if from film were developed or otherwise processed). As shown in FIG. 8, the thumbnail view is derived from subject groupings of images produced by an application 120c, where the images are presented in the appearance of an album. In each case, the selected presentation may be preceded by a screen (not shown) displaying a pull-down menu or a choice of icons indicating available directory names, time line categories or album names associated with the hierarchical, time line and album structures, respectively. A suitable organizational structure is then selected from the menu or the available icons and one of the screens of FIGS. 3, 7 and 8 is opened.

For each organizational view, as represented by any one of the FIGS. 3, 7 and 8, the TAG PAD icon 102 is produced and displayed on the screen for interaction with the user, i.e., the TAG PAD routine is transparent to the user and seemingly “floats” across all applications without any special initiation by the user. This is due to the fact that it is implemented as a layer of the operating system, and not within a specific application. The user can click on the icon 102 anytime, and for any application, and it will open to the TAG PAD palette 120 shown in FIG. 4. In consequence, both the creation of new annotation labels and the annotation of images with existing (or new) labels can be carried on in any application without further specialized effort to open and close applications. Notwithstanding the preferred embodiment, the invention is also intended to extend to the situation where the TAG PAD routine is implemented only within a particular application.

Moreover, since the TAG PAD operates at the operating system level, a search function may be provided that also operates at the operating system level, thereby providing a user-transparent method for accessing all images without having to reference specific applications. In the search methodology that might be used, the user can highlight any number of labels, whether in one or several categories, and then click on a search button (not shown). This causes the computer 8 to initiate a search application, which takes the highlighted words and searches the images in the image database 40, using the address list 44 linking metadata to the images, to generate a search hit list. The picture viewer 46 then displays these images to the user as a thumbnail view, which is then subject to annotation according to the TAG PAD feature disclosed in the preceding paragraphs.

The invention has been described with reference to a preferred embodiment. However, it will be appreciated that variations and modifications can be effected by a person of ordinary skill in the art without departing from the scope of the invention.

Parts List

8 computer

10 operating system

12 user application

14 annotation routine

16 graphical user interface

18 picture archive

20 display

22 input device

24 network interface

26 external network

40 image database

42 metadata database

44 address book

46 picture database viewer

48 sorted image display list

50 screen shots

52 TAG PAD selector

54 TAG PAD agent keyword sorter

100 main directory screen

102 TAG PAD icon

104 thumbnail view

106 thumbnail view

120 TAG PAD palette

122a category set

122b category set

122c category set

124 tags

126 labels

128a scrolling arrow

128b scrolling arrow

130 edit button

132 reset button

134 delete button

136 close button

150 initiate edit step

152 tag selection step

154 create label query

156 reset step

158 labeling step

160 delete label query

162 delete label step

202 open TAG PAD step

204 opened thumbnail view

206 tag choice step

210 drag tag step

212 image choice step

214 drag image step

216 annotation step

218 sort step

220 metadata organize and sort step

What is claimed is:

1. A method for annotating digital images that are presented for viewing in a plurality of organizational structures provided by different application programs run on a common operating system, said method comprising the steps of:
providing a plurality of application programs offering a plurality of organizational structures for viewing the images, wherein each structure presents the images according to a different view;
opening a selected application program, thereby selecting a particular organizational structure and displaying the digital images associated therewith according to the corresponding view;
providing an annotation routine that operates as a layer of the operating system for listing potential labels that may be associated with a digital image, said annotation routine being available concurrently with currently displayed images regardless of the application program that is currently open and displaying the images; and
appending a label to a digital image appearing among the currently displayed images.

2. The method as claimed in claim 1 wherein the step of providing an annotation routine comprises the steps of:
providing an icon appearing concurrently with displayed images regardless of the application program that is currently open; and
opening the icon to display a palette of labels that may be appended to the digital image.

3. The method as claimed in claim 2 wherein the palette of labels is divided into categories of labels.

4. The method as claimed in claim 2 wherein the palette includes a plurality of tags for containing labels, further comprising the steps of: selecting a tag and assigning a label to the selected tag.

5. The method as claimed in claim 4 further comprising the steps of: selecting a tag and deleting a label that was assigned to the selected tag.

6. The method as claimed in claim 1 wherein the step of appending a label to the digital image comprises dragging and dropping the label into the image.

7. The method as claimed in claim 1 wherein the step of appending a label to the digital image comprises dragging and dropping the image into the label.

8. The method as claimed in claim 1 wherein the plurality of organizational structures include hierarchical, time line and album views in which the stored images are linked with a folder-based hierarchy, with the time of capture and with subject grouping structures, respectively.

9. A computer storage medium having instructions stored therein for causing a computer to perform the method of claim 1.

10. A method for annotating digital images that are presented for viewing in a plurality of organizational structures provided by different application programs run on a common operating system, said method comprising the steps of:
providing a plurality of application programs offering a plurality of organizational structures for viewing the images, wherein each structure presents the images according to a different view;
opening a plurality of application programs;
selecting a particular organizational structure associated with a particular application program, thereby displaying the digital images associated therewith according to the corresponding view;
providing an annotation routine that operates as a layer of the operating system for listing potential labels that may be associated with a digital image, said annotation routine being available concurrently with currently displayed images regardless of the application program that is currently open; and
appending a label to a digital image appearing among the currently displayed digital images.

11. The method as claimed in claim 10 wherein the step of providing an annotation routine comprises the steps of:
providing an icon appearing concurrently with displayed images from any of the plurality of application program that are currently open; and
opening the icon to display a palette of labels that may be appended to the digital image.

12. The method as claimed in claim 11 wherein the palette includes a plurality of tags for containing labels, further comprising the steps of: selecting a tag and assigning a label to the selected tag.

13. The method as claimed in claim 12 further comprising the steps of: selecting a tag and deleting a label that was assigned to the selected tag.

14. The method as claimed in claim 10 wherein the plurality of organizational structures include hierarchical, time line and album views in which the stored images are linked with a folder-based hierarchy, with a time of capture and with subject grouping structures, respectively.

15. A computer storage medium having instructions stored therein for causing a computer to perform the method of claim 10.

16. A method for annotating digital images that are presented for viewing in a plurality of organizational structures provided by different application programs run on a common operating system, said method comprising the steps of:
storing a plurality of digital images in a database together with metadata associated with the images;
providing a plurality of application programs offering a plurality of organizational structures for viewing the images stored in the database, wherein each structure presents the images according to a different view;
opening a selected application program, thereby selecting a particular organizational structure and displaying the digital images associated therewith according to the corresponding view;
providing an annotation routine that operates at a layer of the operating system for listing potential labels that may be associated with a digital image, said annotation routine being available concurrently with currently displayed images regardless of the application program that is currently open;
appending a label to a digital image appearing among the currently displayed images; and
storing the label as metadata associated with the digital image in the database.

17. A search method utilizing the labels provided as metadata according to claim 16 to initiate a search at the operating system level, thereby providing user-transparent access across all images without having to reference specific applications.

18. A method for annotating digital images that are presented for viewing in a plurality of organizational structures run by different applications, said method comprising the steps of:
storing a plurality of digital images in a database together with metadata associated with the images;
providing a plurality of applications offering a plurality of organizational structures for viewing the images stored in the database, including hierarchical, time line and album structures in which stored images are linked with a folder-based hierarchy, with a time of capture and with subject groupings, respectively;
generating a palette listing potential labels that may be associated with a digital image produced by any of the applications, said palette appearing concurrently with images viewed from any of the organizational structures;
selecting a particular application offering a particular organizational structure and displaying the digital images associated therewith according to the particular organizational structure;
appending a label from the palette to a digital image appearing among the displayed images.

19. A method for annotating digital images that are presented for viewing in a variety of organizational structures, said method comprising the steps of:
storing a plurality of digital images in a database together with metadata associated with the images;
providing a plurality of organizational structures for viewing the images stored in the database, including hierarchical, time line and album structures in which the stored images are linked with a folder-based hierarchy, with a time of capture and with subject groupings, respectively;
selecting a particular organizational structure and displaying the digital images associated therewith according to the particular selected organizational structure;
displaying an annotation icon concurrently with the displayed images;
subject to user-activation of the annotation icon, displaying a palette listing a plurality of annotation categories in separate sections of the palette, each category providing a plurality of potential labels that may be associated with a digital image;
choosing a label that relates to a selected digital image and annotating the selected image with the chosen label by a drag and drop operation; and
storing metadata associated with the chosen tag with the selected image in the database.

20. The method as claimed in claim 19 further including the step of scrolling through the plurality of potential labels, wherein only a portion of the labels are shown at any one time.
